(19) United States
(12) Patent Application Publication
(10) Pub. No.: US 2021/0082269 A1
(43) Pub. Date: Mar. 18, 2021

(54) Child Tracking Assembly

(71) Applicant: Deidre Harvey, Holly Springs, MS (US)

(72) Inventor: Deidre Harvey, Holly Springs, MS (US)

(21) Appl. No.: 16/573,310

(22) Filed: Sep. 17, 2019

(51) Int. Cl. G08B 21/02; G08B 7/06; H04B 17/318

(52) U.S. Cl. CPC G08B 21/0247; G08B 21/0255; H04B 17/318; G08B 7/06; G08B 21/0288

(57) ABSTRACT

A child tracking assembly for inhibiting a caregiver from leaving a child unattended includes a tracking unit that is wearable on a child's wrist. The tracking unit broadcasts a tracking signal. An electronic device is carried by a caregiver and the electronic device receives the tracking signal. The electronic device emits an audible alarm when the tracking signal falls below a pre-determined signal strength. In this way the electronic device alerts the caregiver that the caregiver has moved beyond a pre-determined distance from the child.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to tracking devices and more particularly pertains to a new tracking device for inhibiting a caregiver from leaving a child unattended.

### (2) Description of Related Art Including Information Disclosed Under 37 CFR 1.97 and 1.98

The prior art relates to tracking devices.

### BRIEF SUMMARY OF THE INVENTION

An embodiment of the disclosure meets the needs presented above by generally comprising a tracking unit that is wearable on a child's wrist. The tracking unit broadcasts a tracking signal. An electronic device is carried by a caregiver and the electronic device receives the tracking signal. The electronic device emits an audible alarm when the tracking signal falls below a pre-determined signal strength. In this way the electronic device alerts the caregiver that the caregiver has moved beyond a pre-determined distance from the child.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a child tracking assembly according to an embodiment of the disclosure.

FIG. 2 is a perspective view of a tracking unit of an embodiment of the disclosure.

FIG. 3 is a schematic view of an embodiment of the disclosure.

### DETAILED DESCRIPTION OF THE INVENTION

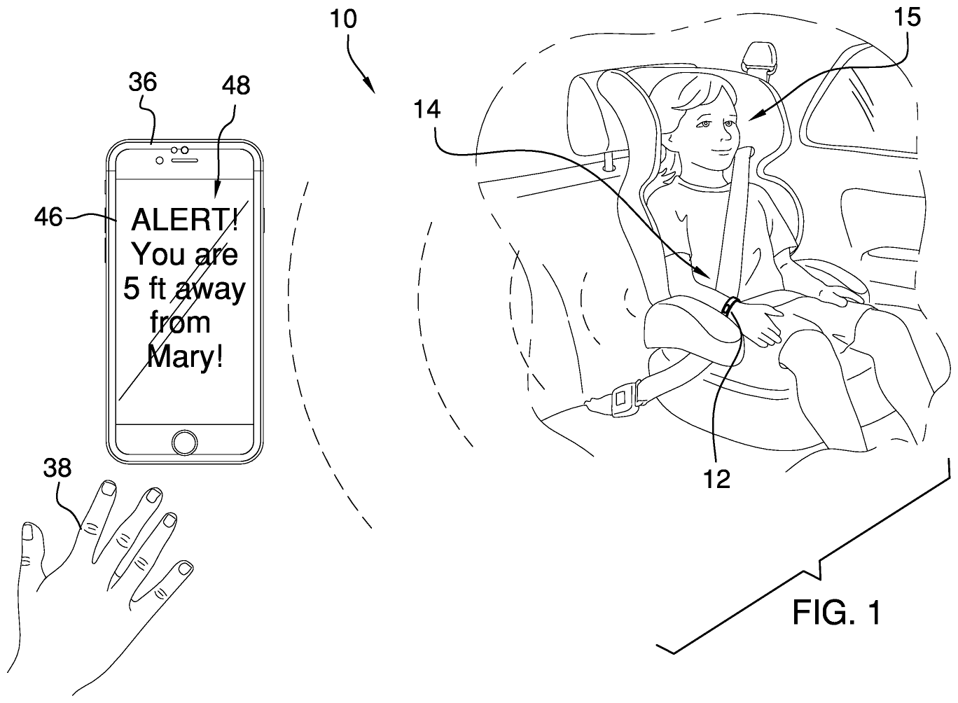

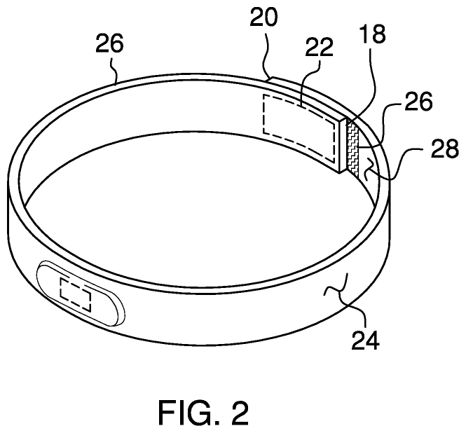

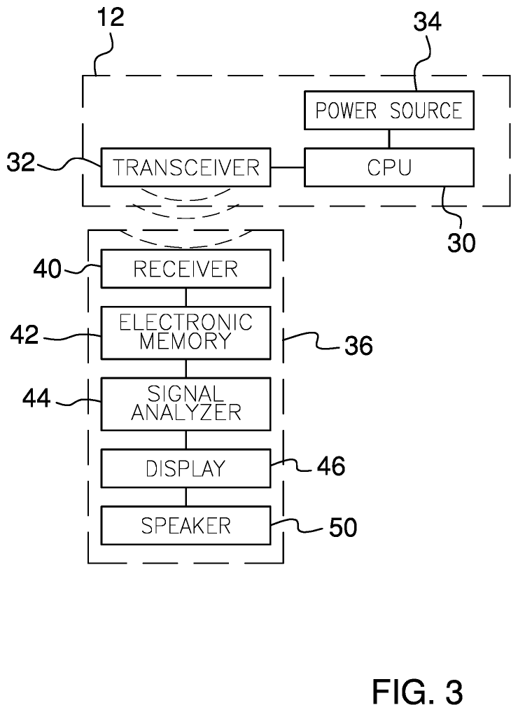

With reference now to the drawings, and in particular to FIGS. 1 through 3 thereof, a new tracking device embodying the principles and concepts of an embodiment of the disclosure and generally designated by the reference numeral 10 will be described.

As best illustrated in FIGS. 1 through 3, the child tracking assembly 10 generally comprises a tracking unit 12 that is wearable on a wrist 14 of a child 15. The tracking unit 12 broadcasts a tracking signal. The tracking unit 12 comprises a bracelet 16 that is wearable around the child's wrist 14. The bracelet 16 is comprised of a fluid impermeable material, and the bracelet 16 has a first end 18 and a second end 20. A first mating member 22 is coupled to a first surface 24 of the bracelet 16 and the first mating member 22 is positioned adjacent to the first end 18. A second mating member 26 is coupled to a second surface 28 of the bracelet 16 and the second mating member 26 is positioned adjacent to the second end 20. The first mating member 22 engages the second mating member 26 to retain the bracelet 16 in a closed loop around the child's wrist 14. Each of the first mating member 22 and the second mating member 26 may comprise hook and loop fasteners or the like.

The tracking unit 12 includes a control circuit 30 that is coupled to the bracelet 16. a transmitter 32 is coupled to the bracelet 16. The transmitter 32 is electrically coupled to the control circuit 30 and the transmitter 32 broadcasts the tracking signal. The transmitter 32 may be a radio frequency transmitter or the like and the transmitter 32 may employ Bluetooth communication protocols. A power supply 34 is coupled to the bracelet 16, the power supply 34 is electrically coupled to the control circuit 30 and the power supply 34 comprises at least one battery.

An electronic device 36 is included and the electronic device 36 is carried by a caregiver 38. The electronic device 36 receives the tracking signal. Additionally, the electronic device 36 emits an audible alarm when the tracking signal falls below a pre-determined signal strength. In this way the electronic device 36 alerts the caregiver 38 that the caregiver 38 has moved beyond a pre-determined distance from the child 15. The electronic device 36 may be a smart phone or other similar type of personal electronic device.

The electronic device 36 includes a receiver 40 that is coupled to the electronic device 36 and the receiver 40 receives the tracking signal from the transmitter 32. The receiver 40 may be a radio frequency receiver or the like and the receiver 40 may employ Bluetooth communication protocols. The electronic device 36 includes an electronic memory 42 that stores data comprises tracking software. A signal analyzer 44 is included and the signal analyzer 44 is in electrical communication with the receiver 40. The signal analyzer 44 communicates an alert input to the tracking software when the signal analyzer 44 determines the strength of the tracking signal has fallen below a pre-determined threshold.

A display 46 is coupled to the electronic device 36 such that the display 46 is visible to the caregiver 38. The display 46 displays alert indicia 48 when the tracking software receives the alert input. In this way the caregiver 38 is alerted that the caregiver 38 has moved beyond the pre-determined distance from the child 15. Additionally, the electronic device 36 may include a speaker 50 that emits an audible alarm when the tracking software receives the alert input. The pre-determined distance for alerting the caregiver 38 may be programmed with the tracking software. Additionally, the name of the child 15 may be programmed into the tracking software.

In use, the bracelet 16 is worn around the child's wrist 14 and the tracking unit 12 is synched with the electronic device 36. The pre-determined distance and the child's name are programmed into the tracking software. The display 46 displays the alert indicia 48 and the speaker 50 emits the audible alarm when the caregiver 38 moves beyond the pre-determined distance from the child 15. In this way the caregiver 38 is inhibited from inadvertently leaving the child 15 unattended in a vehicle or the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A child tracking assembly being configured to alert a caregiver when the caregiver moves a pre-determined distance away from a child, said assembly comprising:
a tracking unit being wearable on a child's wrist, said tracking unit broadcasting a tracking signal; and
a electronic device being carried by a caregiver, said electronic device receiving said tracking signal, said electronic device emitting an audible alarm when said tracking signal falls below a pre-determined signal strength wherein said electronic device is configured to alert the caregiver that the caregiver has moved beyond a pre-determined distance from the child.

2. The assembly according to claim 1, wherein said tracking unit comprises:
a bracelet being wearable around the child's wrist, said bracelet being comprised of a fluid impermeable material, said bracelet having a first end and a second end;
a first mating member being coupled to a first surface of said bracelet, said first mating member being positioned adjacent to said first end; and
a second mating member being coupled to a second surface of said bracelet, said second mating member being positioned adjacent to said second end, said first mating member engaging said second mating member to retain said bracelet in a closed loop around the child's wrist.

3. The assembly according to claim 2, wherein said tracking unit comprises:
a control circuit being coupled to said bracelet; and
a transmitter being coupled to said bracelet, said transmitter being electrically coupled to said control circuit, said transmitter broadcasting said tracking signal.

4. The assembly according to claim 3, wherein said tracking unit comprises a power supply being coupled to said bracelet, said power supply being electrically coupled to said control circuit, said power supply comprising at least one battery.

5. The assembly according to claim 3, wherein said electronic device includes a receiver being coupled to said electronic device, said receiver receiving said tracking signal from said transmitter.

6. The assembly according to claim 5, wherein said electronic device includes an electronic memory being coupled to said electronic device, said electronic memory storing data comprising tracking software.

7. The assembly according to claim 6, wherein said electronic device includes a signal analyzer being coupled to said electronic device, said signal analyzer being electrically coupled to said receiver, said signal analyzer communicating an alert input to said tracking software when said signal analyzer determines the strength of said tracking signal has fallen below a pre-determined threshold.

8. The assembly according to claim 7, wherein said electronic device includes a display being coupled to said electronic device such that said display is visible to the caregiver, said display displaying alert indicia when said tracking software receives said alert input thereby alerting the caregiver that the caregiver has moved beyond the pre-determined distance from the child.

9. A child tracking assembly being configured to alert a caregiver when the caregiver moves a pre-determined distance away from a child, said assembly comprising:
a tracking unit being wearable on a child's wrist, said tracking unit broadcasting a tracking signal, said tracking unit comprising:
a bracelet being wearable around the child's wrist, said bracelet being comprised of a fluid impermeable material, said bracelet having a first end and a second end;
a first mating member being coupled to a first surface of said bracelet, said first mating member being positioned adjacent to said first end;
a second mating member being coupled to a second surface of said bracelet, said second mating member being positioned adjacent to said second end, said first mating member engaging said second mating member to retain said bracelet in a closed loop around the child's wrist;
a control circuit being coupled to said bracelet;
a transmitter being coupled to said bracelet, said transmitter being electrically coupled to said control circuit, said transmitter broadcasting said tracking signal; and
a power supply being coupled to said bracelet, said power supply being electrically coupled to said control circuit, said power supply comprising at least one battery; and
a electronic device being carried by a caregiver, said electronic device receiving said tracking signal, said electronic device emitting an audible alarm when said tracking signal falls below a pre-determined signal strength wherein said electronic device is configured to alert the caregiver that the caregiver has moved beyond a pre-determined distance from the child, said electronic device including:
a receiver being coupled to said electronic device, said receiver receiving said tracking signal from said transmitter;
an electronic memory being coupled to said electronic device, said electronic memory storing data comprising tracking software;
a signal analyzer being coupled to said electronic device, said signal analyzer being electrically coupled to said receiver, said signal analyzer communicating an alert input to said tracking software when said signal analyzer determines the strength of said tracking signal has fallen below a pre-determined threshold; and
a display being coupled to said electronic device such that said display is visible to the caregiver, said display displaying alert indicia when said tracking software receives said alert input thereby alerting the caregiver that the caregiver has moved beyond the pre-determined distance from the child.
